(19) United States
(12) Patent Application Publication
(10) Pub. No.: US 2011/0299714 A1
(43) Pub. Date: Dec. 8, 2011

(54) EARPHONE FOR REPLACEABLE CABLES

(76) Inventors: Mou-Ming Ma, Taipei (TW); Shu-I Cheh, Taipei (TW)

(21) Appl. No.: 12/795,126

(22) Filed: Jun. 7, 2010

(51) Int. Cl. H04R 1/10

(52) U.S. Cl. 381/384

(57) ABSTRACT

An earphone to fit with a plurality of audio cables with difference application lengths includes an earphone body and a first buckle structure. The earphone body further includes an audio jack to couple with an audio terminal of a relevant audio cable with an appropriate application length. The first buckle structure is located at the audio jack for providing a firm connection between the audio terminal and the audio jack. By providing the earphone body to engage firmly the audio cable with an appropriate application length in a separable manner, any application situation featuring a particular application length can be easily overcome.

### BACKGROUND OF THE INVENTION

(1) Field of the Invention

This invention relates to an earphone, more particularly to an earphone that provides connection-ability to various cables.

(2) Description of the Prior Art

In the art, an earphone usually has a fixed extension cable. Referred to FIG. 1, a typical conventional earphone is shown. The earphone 1 includes a left earplug 11, a right earplug 12 and an audio cable 13. The audio cable 13 further includes an audio terminal 131. The left earplug 11 is electrically connected with the right earplug 12, and the audio cable 13 is particularly electrically connected to the left earplug 12. The audio terminal 131 is to couple with an audio jack (not shown in the figure) of an audio source device so as to capture audio media provided by the audio source device. Through the audio cable 13, the audio media can be then transmitted to the left earplug 11 and the right earplug 12 for broadcasting therefrom.

It is noted that, in a conventional earphone design as disclosed in FIG. 1, the earphone 1 has a fixed inseparable audio cable 13, which is connected electrically to one of the earplugs 11 and 12. For the length of the audio cable 13 is fixed, the applicable length of the earphone 1 to the audio source device is limited to the particular audio cable 13. Such a fixed-length application of the earphone 1 may cause some inconvenience. For an instance, for a lengthy audio cable 13 to be used in a short-length application environment, the audio cable 13 is usually forced to be wrapped, bent or rolled to fit the limited space. However, such a physical means to shorten the usage length of the audio cable 13 is sometimes led to a short service life of the audio cable 13. On the other hand, in the case that a short audio cable 13 is used to a lengthy application environment, an additional extension cable is usually needed to be connected to the audio terminal 131 of the audio cable 13. Otherwise, the audio terminal 131 is opt to be pull off the audio jack of the audio source device due to unexpected pull forcing from the short-length cable. It is easy to see that the extension cable is definite a cost and may cause some carrying inconvenience.

Therefore, the need to provide an earphone structure that can resolve the aforesaid inconvenience in conventional earphone usage is definitely obvious

### SUMMARY OF THE INVENTION

Accordingly, it is a primary object of the present invention to provide an earphone for replaceable cables. The earphone of the present invention applicable to adapt cables with various lengths comprises an earphone body further having an audio jack to electrically couple with one of the cables.

It is another object of the present invention to provide an earphone that can ensure the separable connection between the earphone body and the cable by providing a first buckle structure to the earphone body.

In the present invention, the earphone includes an earphone body that can receive, in a separable manner, one of plural audio cables with different lengths. Each of the audio cables has an individual audio terminal. The earphone further includes a first buckle structure to ensure the separable connection between the audio jack of the earphone body and the audio terminal of a respective audio cable. Preferably, the first buckle structure can be located at the audio jack.

By providing the separable connection between the earphone body of the earphone and one of the audio cables with various application lengths in accordance with the present invention, the earphone can then be applicable conveniently to various application environments of the audio source device without the aforesaid problems described in the background section.

All these objects are achieved by the earphone for replaceable cables described below.

### BRIEF DESCRIPTION OF THE DRAWINGS

The present invention will now be specified with reference to its preferred embodiment illustrated in the drawings, in which:

FIG. 1 shows a typical convention earphone;

FIG. 2A and FIG. 2B show a first embodiment of the earphone for replaceable cables in accordance with the present invention;

FIG. 3A and FIG. 3B show a buckle-up operation of the first embodiment;

FIG. 4A and FIG. 4B show a pull-off operation of the first embodiment; and

FIG. 5A and FIG. 5B show a second embodiment of the earphone for replaceable cables in accordance with the present invention

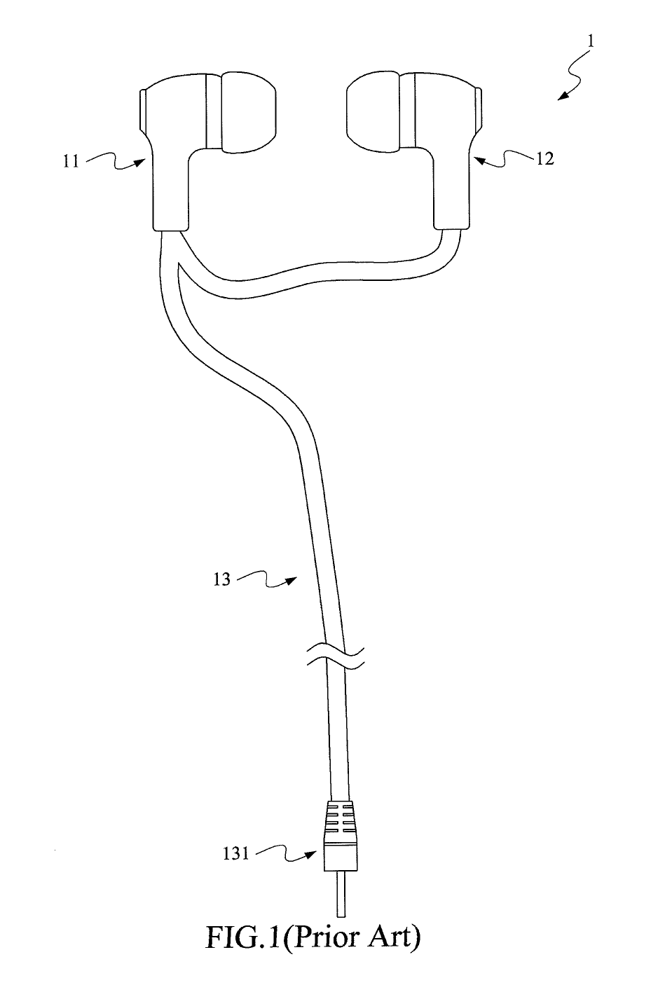

### DESCRIPTION OF THE PREFERRED EMBODIMENT

The invention disclosed herein is directed to an earphone for replaceable cables. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

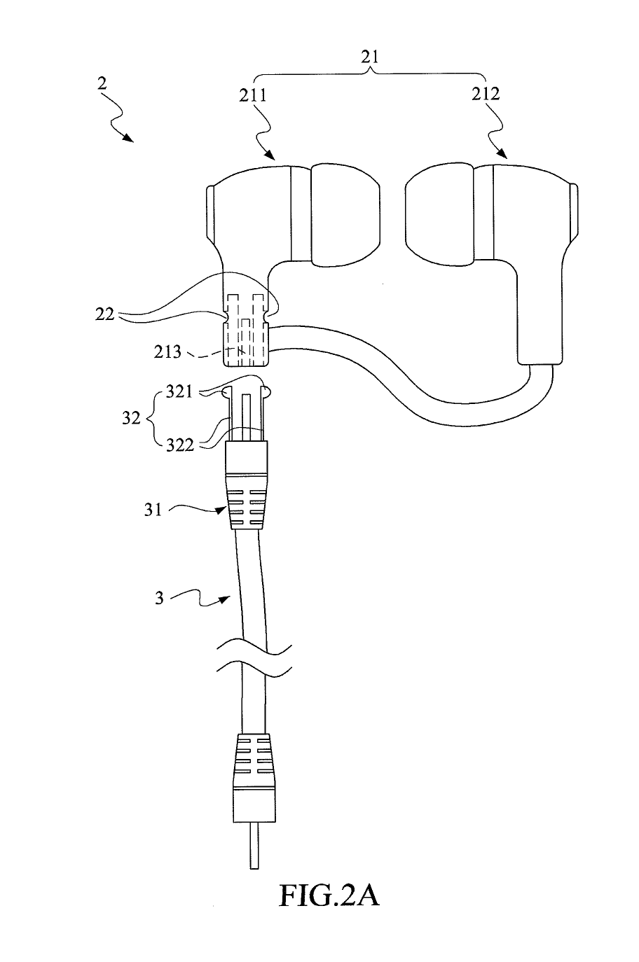

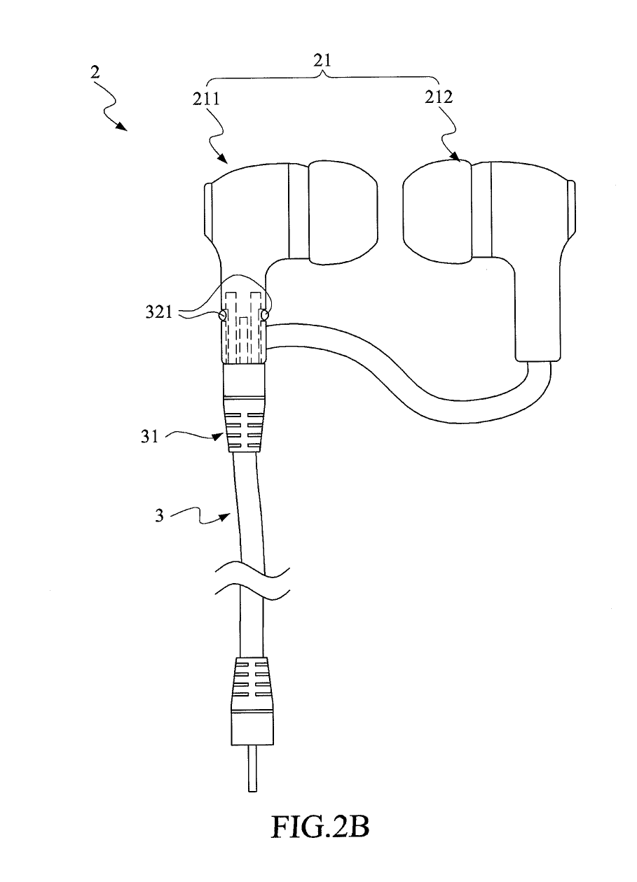

Referring now to FIG. 2A and FIG. 2B, a first embodiment of the earphone for replaceable cables in accordance with the present invention is shown. The earphone 2 of the invention is to go with a plurality of audio cables 3 with various application lengths. Each of the audio cables 3 has an individual audio terminal 31. The earphone 2 includes an earphone body 21 and a first buckle structure 22. In this embodiment as shown in FIG. 2A and FIG. 2B, the first buckle structure 22 is formed as an anchoring hole□

The earphone body 21 further includes a first earphone body 211, a second earphone body 212 and an audio jack 213. The first earphone body 211 and the second earphone body 212 are electrically connected. The audio jack 213 is constructed to the first earphone body 211.

In the present invention, the earphone body 21 can be selected from the group of earplug-type earphones, ear-hang-type earphones, head-hookup-type earphones and ear-shielding-type earphones, and the audio jack 213 can be any of the standard 2.5 mm, 3.5 mm and 6.3 mm jacks.

The anchoring hole 22 is located at the audio jack 213. Upon while the earphone 2 is coupled with any one of the audio cables 3, the audio terminal 3 of the audio cable 3 is plugged in the audio jack 213 of the first earphone body 21.

Further, the audio cable 3 can include a second buckle structure. As shown in this first embodiment, the second buckle structure is formed as a latch 32 built at the audio terminal 31 to match with the anchoring hole 22 of the first earphone body 21.

The latch 32 as shown includes a stop protrusion 321 and a spring element 322. The stop protrusion 321 is to plug the anchoring hole 22 while the audio terminal 31 mates the audio jack 213. One end of the spring element 322 is connected to the stop protrusion 321, while another end thereof is contacted to the audio terminal 31.

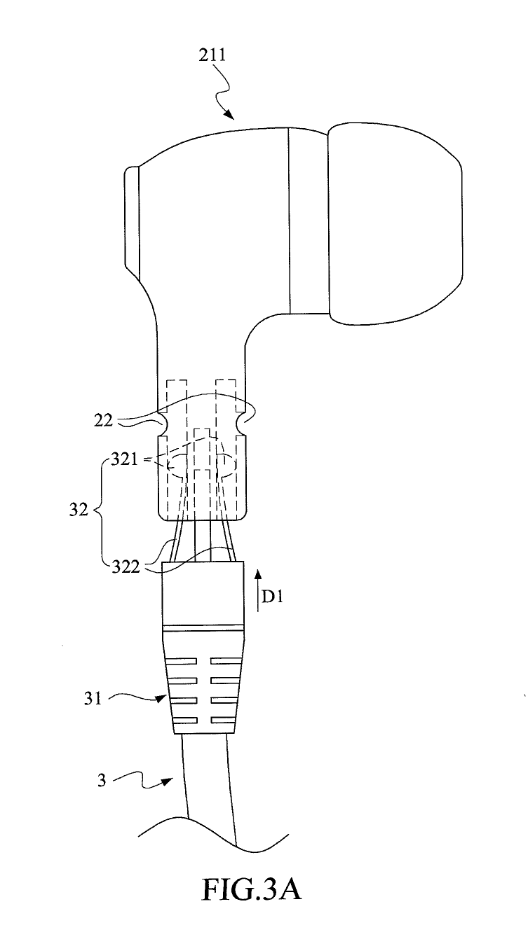

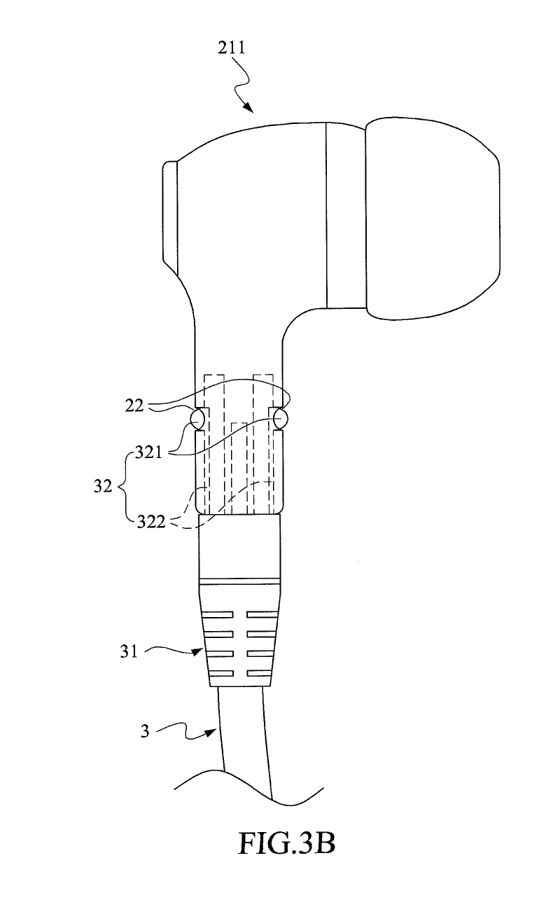

Referring now to FIG. 3A and FIG. 3B, a typical buckle-up operation of the first embodiment of the earphone is shown. In the present invention, the user of the earphone 2 can choose one of the audio cables 3 with an appropriate application length to match the first earphone body 211. In connection, the audio terminal 31 is sent along a first movement direction D1 to plug the audio jack 213. Meanwhile, the stop protrusion 321 is compressed by the interior wall of the audio jack 213 to further depress the spring element 322 inward so as to firmly hold the stop protrusion 321 inside the audio jack 213.

By providing the elastic forcing of the spring element 322 while the audio terminal 31 mates the audio jack 213 along the direction D11 in accordance with the present invention, the stop protrusion 321 can buckle up with the anchoring terminal 31 can firmly engage together.

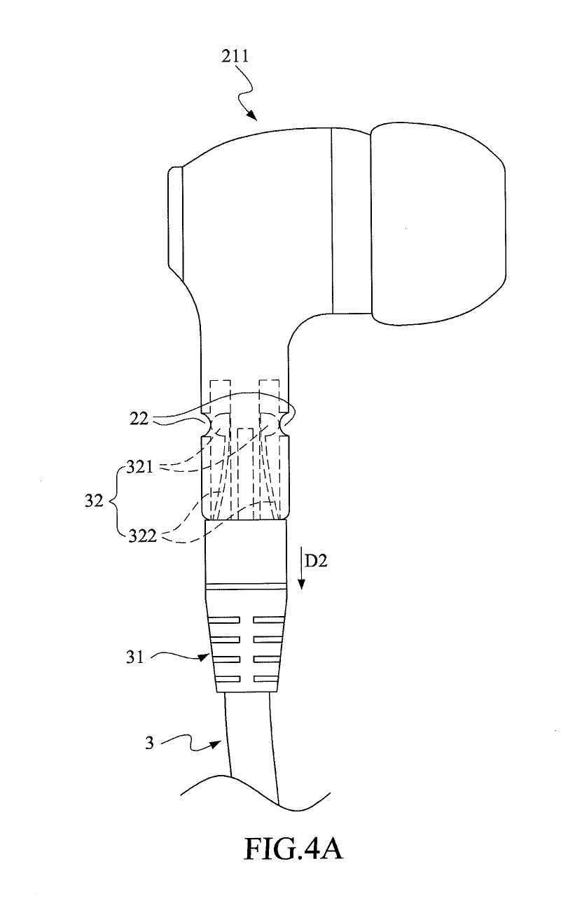

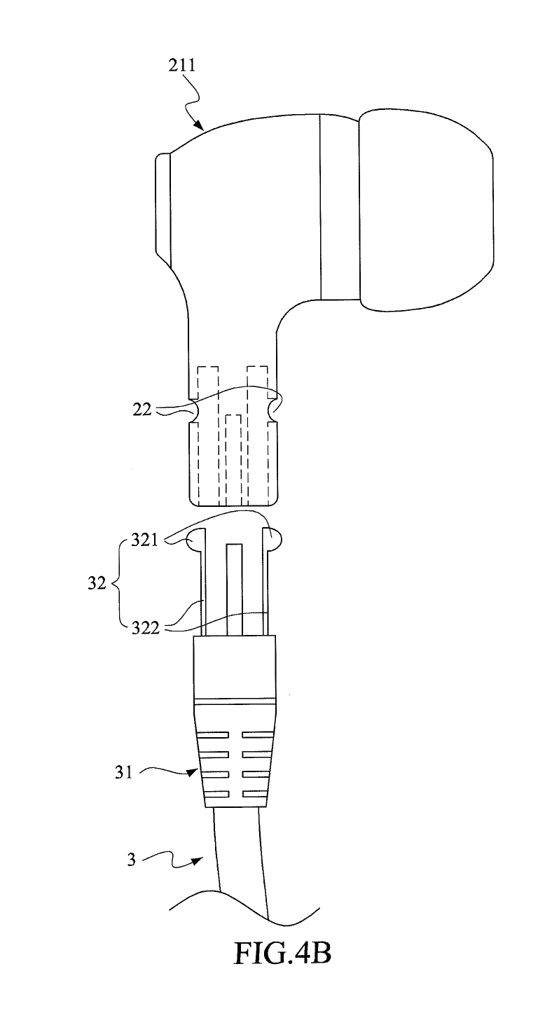

Referring now to FIG. 4A and FIG. 4B, a typical pull-off operation of the first embodiment of the earphone is shown. While in a pull-off operation, the stop protrusion 321 is firstly depressed to deflect the spring element 322 inward so as to have the stop protrusion 321 leave the anchoring hole 22, and then the audio terminal 31 can be pulled off the audio jack 213 along a second movement direction D2.

While the audio terminal 31 totally leaves the audio jack 23, the spring element 322 can resume to its original free state.

By providing the present invention, the user of the earphone can arbitrarily choose a proper audio cable 3 with an appropriate application length. With the help of the buckle-up operation between the stop protrusion 32 (i.e. the latch) and the anchoring hole 22, the audio terminal 31 of the audio cable 3 can be firmly held by the audio jack 213 of the first earphone body 21. Upon such an arrangement, since the appropriate application length can be provided to the audio cable 3 to meet various application situations, any abrupt movement that shocks the combination of the audio cable 3 and the earphone body 2 cannot separate the earphone assembly of the present invention.

Further, in the case of applying a huge-occupation audio device which is hard to be moved in any time, the application of the earphone can become versatile with the help of plenty extension audio cables 3 with various application lengths.

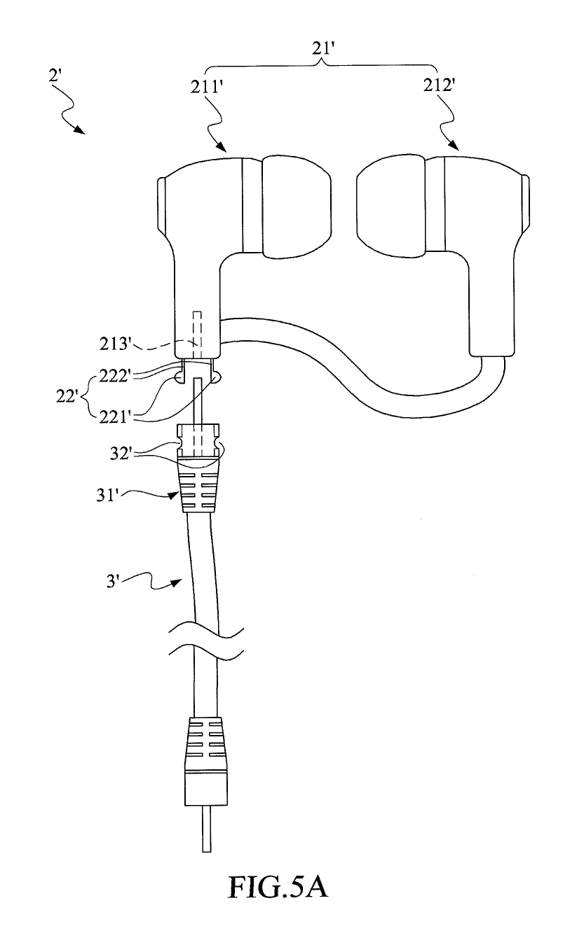

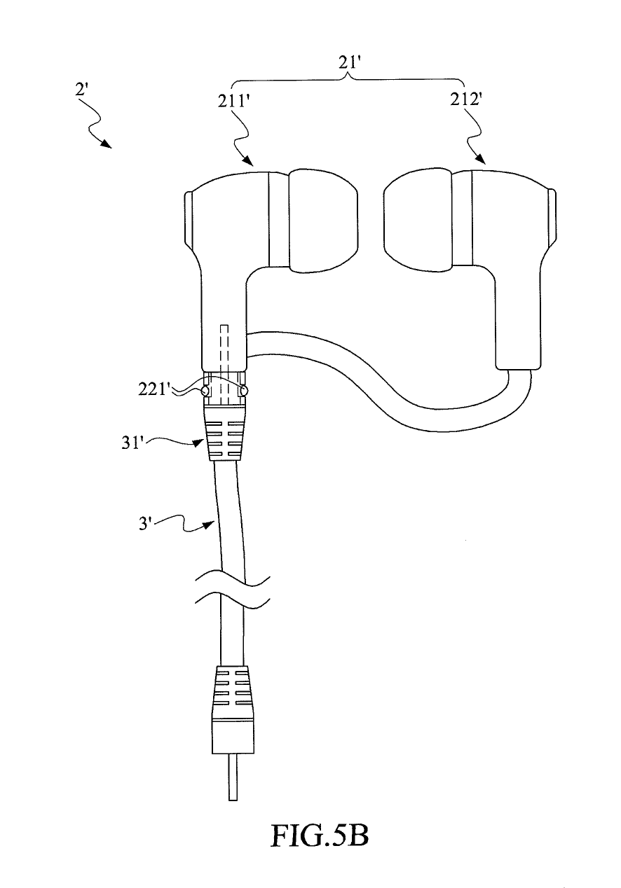

Referring now to FIG. 5A and FIG. 5B, a second embodiment of the earphone for replaceable cables in accordance with the present invention is shown. The earphone 2′ of the invention is also to go with a plurality of audio cables 3′ with various application lengths. Each of the audio cables 3′ has an individual audio terminal 31′. The earphone 2′ includes an earphone body 21′ and a first buckle structure 22′. In this embodiment as shown in FIG. 5A and FIG. 5B, the first buckle structure 22′ is formed as a latch 22′.

The earphone body 21′ further includes a first earphone body 211′, a second earphone body 212′ and an audio jack 213′. The first earphone body 211′ and the second earphone body 212′ are electrically connected. The audio jack 213′ is constructed to the first earphone body 211′. The earphone body 21′ can be selected from the group of earplug-type earphones, ear-hang-type earphones, head-hookup-type earphones and ear-shielding-type earphones, and the audio jack 213′ can be any of the standard 2.5 mm, 3.5 mm and 6.3 mm jacks.

Upon while the earphone 2′ is coupled with any one of the audio cables 3′, the audio terminal 3′ of the audio cable 3′ is plugged in the audio jack 213′ of the first earphone body 21′.

Further, the audio cable 3′ can include a second buckle structure. As shown in this second embodiment, the second buckle structure is formed as an anchoring hole 32′ built at the audio terminal 31′ to match with the latch 22′ of the first earphone body 21′.

The latch 22′ as shown includes a stop protrusion 221′ and a spring element 222′. The stop protrusion 221′ is to plug the anchoring hole 32′ while the audio terminal 31′ mates the audio jack 213′. One end of the spring element 222′ is connected to the stop protrusion 221′, while another end thereof is contacted to the audio jack 213′.

Beside the aforesaid structural differences between the first embodiment and the second embodiment in accordance with the present invention, the foregoing buckle-up and pull-off operations of the first embodiment are also applied to the second embodiment. Therefore, details thereabout are omitted herein.

By providing the separable connection and the firm-engagement buckle mechanism between the earphone body 2, 2′ of the earphone and one of the audio cables 3, 3′ with various application lengths in accordance with the present invention, the earphone can then be applicable conveniently to various application environments of any type of the audio source devices without the aforesaid problems described in the background section.

While the present invention has been particularly shown and described with reference to a preferred embodiment, it will be understood by those skilled in the art that various changes in form and detail may be without departing from the spirit and scope of the present invention.

I claim:

1. An earphone to fit with a plurality of audio cables having individual audio terminals, comprising:
an earphone body, further including an audio jack to couple with one of the audio terminals; and
a first buckle structure, located at the audio jack for providing a firm connection between said one of the audio terminals and the audio jack.

2. The earphone according to claim 1, wherein said earphone body further includes a first earphone body and said audio jack is located at the first earphone body.

3. The earphone according to claim 2, wherein said earphone body further includes a second earphone body electrically connected with said first earphone body.

4. The earphone according to claim 1, wherein said earphone body is selected from the group of earplug-type earphones, ear-hang-type earphones, head-hookup-type earphones and ear-shielding-type earphones.

5. The earphone according to claim 1, wherein said first buckle structure includes at least a latch.

6. The earphone according to claim 5, wherein said latch further includes:
a stop protrusion to be received by an anchoring hole of said audio jack upon while said audio terminal is coupled with said audio jack; and
a spring element mounted to the stop protrusion.

7. The earphone according to claim 6, wherein said audio terminal further includes a second buckle structure having said anchoring hole.

8. The earphone according to claim 1, wherein said first buckle structure includes at least an anchoring hole, said audio terminal further includes a second buckle structure having at least a latch to pair with the anchoring hole.

9. The earphone according to claim 8, wherein said latch further includes:
a stop protrusion to be received by said anchoring hole upon while said audio terminal is coupled with said audio jack; and
a spring element mounted to the stop protrusion.
